(19) United States
(12) Patent Application Publication
(10) Pub. No.: US 2023/0192955 A1
(43) Pub. Date: Jun. 22, 2023

(54) POLYIMIDE PRECURSOR SOLUTION, POROUS POLYIMIDE FILM, AND INSULATED WIRE

(71) Applicant: FUJIFILM Business Innovation Corp., Tokyo (JP)

(72) Inventors: Kosuke NAKADA, Kanagawa (JP); Hidekazu HIROSE, Kanagawa (JP); Kosaku YOSHIMURA, Kanagawa (JP); Shigeru SEITOKU, Kanagawa (JP); Hajime SUGAHARA, Kanagawa (JP); Satoshi YOSHIDA, Kanagawa (JP)

(73) Assignee: FUJIFILM Business Innovation Corp., Tokyo (JP)

(21) Appl. No.: 17/827,780

(22) Filed: May 29, 2022

(30) Foreign Application Priority Data
Dec. 20, 2021 (JP) 2021-206468

(51) Int. Cl. C08G 73/10; H01B 3/30; C08J 5/18

(52) U.S. Cl. CPC C08G 73/1007; H01B 3/306; C08J 5/18; C08J 2379/08

(57) ABSTRACT

A polyimide precursor solution includes a polyimide precursor that is a polymer of an aromatic tetracarboxylic dianhydride and an aromatic diamine compound, resin particles, an aqueous solvent containing water, and an amine compound having a boiling point of equal to or higher than 250° C. and equal to or lower than 300° C., in which a ratio of a volume of the resin particles to a volume of the amine compound (volume of resin particles/volume of amine compound) is equal to or more than 0.22 and equal to or less than 0.61.

### CROSS-REFERENCE TO RELATED APPLICATIONS

This application is based on and claims priority under 35 USC 119 from Japanese Patent Application No. 2021-206468 filed Dec. 20, 2021.

### BACKGROUND

### (i) Technical Field

The present invention relates to a polyimide precursor solution, a porous polyimide film, and an insulated wire.

### (ii) Related Art

JP2021-095558A suggests “a polyimide precursor solution including a polyimide precursor and an aqueous solvent including an imidazole compound (A), a tertiary amine compound (B) other than the imidazole compound, and water, in which a ratio of the number of moles of the imidazole compound (A) to the number of moles of a tetracarboxylic dianhydride component of the polyimide precursor is equal to or more than 0.2 times and equal to or less than 1.6 times the mole, a ratio of the number of moles of the tertiary amine compound (B) to the number of moles of the imidazole compound (A) is equal to or more than 0.3 times and equal to or less than 6.0 times the mole, and the water content is equal to or more than 50% by mass with respect to the aqueous solvent”.

### SUMMARY

Aspects of non-limiting embodiments of the present disclosure relate to a polyimide precursor solution that includes a polyimide precursor that is a polymer of an aromatic tetracarboxylic dianhydride and an aromatic diamine compound, resin particles, an aqueous solvent containing water, and an amine compound having a boiling point of equal to or higher than 250° C. and equal to or lower than 300° C., in which a porous polyimide film having a high porosity and a high independent porosity is obtained, compared to a case where a ratio of a volume of the resin particles to a volume of the amine compound (volume of resin particles/volume of amine compound) is less than 0.22 or more than 0.61.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a polyimide precursor solution including a polyimide precursor that is a polymer of an aromatic tetracarboxylic dianhydride and an aromatic diamine compound, resin particles, an aqueous solvent containing water, and an amine compound having a boiling point of equal to or higher than 250° C. and equal to or lower than 300° C., in which a ratio of a volume of the resin particles to a volume of the amine compound (volume of resin particles/volume of amine compound) is equal to or more than 0.22 and equal to or less than 0.61.

### BRIEF DESCRIPTION OF THE DRAWINGS

Exemplary embodiment(s) of the present invention will be described in detail based on the following FIGURES, wherein:

FIG. 1 is a process diagram showing an example of a method for producing a porous polyimide film of the present exemplary embodiment.

### DETAILED DESCRIPTION

Hereinafter, an exemplary embodiment which is an example of the present invention will be described. Descriptions and examples herein exemplify exemplary embodiments and do not limit the scope of the invention.

In the numerical value range described stepwise in the present specification, an upper limit value or a lower limit value described in one numerical value range may be substituted with an upper limit value or a lower limit value of another numerical value range described stepwise. In addition, in the numerical value range described in the present specification, the upper limit value or the lower limit value of the numerical value range may be substituted with the value shown in the examples.

Each component may contain a plurality of substances.

In a case of referring to an amount of each component in a composition, in a case where a plurality of substances corresponding to each component is present in the composition, unless otherwise specified, the amount means a sum of the plurality of substances present in the composition.

“Film” is a concept that includes not only what is generally called “film” but also what is generally called “membrane” and “sheet”.

In the present specification, the term of “step” is included in the present term as long as an intended purpose of the step is achieved not only as an independent step but also in a case where the step is not clearly distinguished from other steps.

Each component may contain a plurality of substances.

In the present specification, “(meth)acrylic” means that both “acrylic” and “methacryl” are included.

In the present specification, unless otherwise specified, “boiling point” means a boiling point under atmospheric pressure (101.3 kPa).

Polyimide Precursor Solution

A polyimide precursor solution according to the present exemplary embodiment contains a polyimide precursor that is a polymer of an aromatic tetracarboxylic dianhydride and an aromatic diamine compound, resin particles, an aqueous solvent containing water, and an amine compound having a boiling point of equal to or higher than 250° C. and equal to or lower than 300° C.

A ratio of a volume of the resin particles to a volume of the amine compound (volume of resin particles/volume of amine compound) is equal to or more than 0.22 and equal to or less than 0.61.

As the polyimide precursor solution according to the present exemplary embodiment, a porous polyimide film having a high porosity and a high independent porosity can be obtained by the configuration. The reason is presumed as follows.

In a case where a porous polyimide film obtained by using a polyimide precursor containing a polyimide precursor that is a polymer of an aromatic tetracarboxylic dianhydride and an aromatic diamine compound, resin particles, an aqueous solvent containing water, and an amine compound having a boiling point of equal to or higher than 250° C. and equal to or lower than 300° C. has a high porosity, there is a case where pores easily communicate with each other and an independent porosity is easily lowered.

By setting the ratio of the volume of the resin particles to the volume of the amine compound (volume of resin particles/volume of amine compound) to equal to or more than 0.22 and equal to or less than 0.61, the content ratio of the amine compound and the resin particles in the polyimide precursor becomes appropriate, and it becomes easy to obtain a porous polyimide film having a high porosity and a high independent porosity.

In a case where the content ratio of the amine compound to the resin particles is too large, pores derived from droplets of the amine compound may occur in the production of the porous polyimide film, and with this, communication between the pores may become easy. By setting the ratio (volume of resin particles/volume of amine compound) to equal to or more than 0.22, the content ratio of the amine compound to the particles does not become too large, and the generation of pores derived from the droplets of the amine compound is suppressed. Therefore, the independent porosity easily becomes high.

By setting the ratio (volume of resin particles/volume of amine compound) to 0.61 or less, the content ratio of resin particles to the amine compound does not become too large. Therefore, in the production of the porous polyimide film, an appropriate gap easily occurs between the resin particles, and the independent porosity easily becomes high.

In addition, in a case where a polymer of an aromatic tetracarboxylic dianhydride and an aromatic diamine compound is used as the polyimide precursor, polyimide obtained from the polymer easily has high mechanical strength. Therefore, in the production of the porous polyimide film, in a case where a coating film of the polyimide precursor solution is heated, the mechanical strength of the coating film is increased, and thus a shape of the pores is easily maintained. Therefore, in the production of the porous polyimide film, the generated independent pores are difficult to communicate with other pores, and the independent porosity easily becomes high.

In addition, by setting the boiling point of the amine compound to equal to or higher than 250° C. and equal to or less than 300° C., the amine compound easily remains in the coating film until the imidization of the polyimide precursor is completed in the production of the porous polyimide film. Therefore, the volume shrinkage of the porous polyimide film due to the volatilization of the amine compound is suppressed, and the porosity easily becomes high.

From the above, it is presumed that the polyimide precursor solution can obtain a porous polyimide film having a high porosity and a high independent porosity.

Polyimide Precursor

The polyimide precursor is a polymer of an aromatic tetracarboxylic dianhydride and an aromatic diamine compound.

The aromatic tetracarboxylic dianhydride is a tetracarboxylic dianhydride containing an aromatic organic group.

On the other hand, the aromatic diamine compound is a diamine compound having two amino groups and an aromatic organic group in the molecular structure.

The aromatic organic group is an organic group having an aromatic ring.

The organic group is a functional group containing at least one atom selected from the group consisting of a carbon atom, a hydrogen atom, an oxygen atom, a nitrogen atom, a phosphorus atom, a sulfur atom, and a halogen atom.

Specifically, the polyimide precursor is a resin (polyamic acid) having a repeating unit represented by General Formula (I).

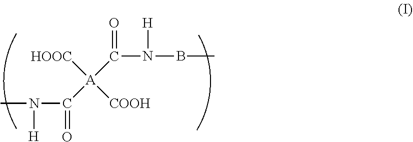

(In General Formula (I), A represents a tetravalent organic group and B represents a divalent organic group.)

Here, in General Formula (I), examples of the tetravalent organic group represented by A include a residue obtained by removing four carboxyl groups from the aromatic tetracarboxylic dianhydride used as a raw material. That is, in General Formula (I), the tetravalent organic group represented by A is an aromatic organic group.

On the other hand, examples of the divalent organic group represented by B include a residue obtained by removing two amino groups from the aromatic diamine compound used as a raw material. That is, in General Formula (I), the divalent organic group represented by B is an aromatic organic group.

Examples of the aromatic tetracarboxylic dianhydride include pyromellitic acid anhydride, 3,3′,4,4′-benzophenone tetracarboxylic dianhydride, 3,3′,4,4′-diphenylsulfone tetracarboxylic dianhydride, 4,4′-oxydiphthalic acid anhydride, 3,4′-oxydiphthalic acid anhydride, 3,3′,4,4′-biphenyl tetracarboxylic dianhydride, 2,3,3′,4′-biphenyl tetracarboxylic dianhydride, 4,4′-(hexafluoroisopropylidene)diphthalic acid anhydride, 2,2-bis(3,4-dicarboxyphenyl)propane dianhydride, bis(3,4-dicarboxyphenyl)methane dianhydride, 1,4-bis(3,4-dicarboxyphenoxy)benzene dianhydride, 1,4-bis(2,3-dicarboxyphenoxy)benzene dianhydride, p-phenylene bis(trimellitate anhydride), m-phenylene bis(trimellitate anhydride), 2,2-bis[4-(3,4-dicarboxyphenoxy)phenyl]propane dianhydride, naphthalene-1,4,5,8-tetracarboxylic dianhydride, naphthalene-2,3,6,7-tetracarboxylic dianhydride, 9,9-bis (3,4-dicarboxyphenyl) fluorene dianhydride, 4,4′-diphenylether bis(trimellitate anhydride), 4,4′-diphenylmethane bis(trimellitate anhydride), 4,4′-bis(3,4-dicarboxyphenoxy)diphenylsulfide dianhydride, 4,4′-bis(3,4-dicarboxyphenoxy)diphenylsulfone dianhydride, 4,4′-bis(3,4-dicarboxyphenoxy)diphenylether dianhydride, 2,2-bis(4-hydroxyphenyl)propane bis(trimellitate anhydride), p-terphenyl tetracarboxylic dianhydride, m-terphenyl tetracarboxylic dianhydride, and the like.

Among these, specific examples of the aromatic tetracarboxylic dianhydride may include pyromellitic acid anhydride, 3,3′,4,4′-benzophenone tetracarboxylic dianhydride, 4,4′-oxydiphthalic acid anhydride, 3,3′,4,4′-biphenyl tetracarboxylic dianhydride, 2,3,3′,4′-biphenyl tetracarboxylic dianhydride, may further include pyromellitic acid dianhydride, 3,3′,4,4′-biphenyl tetracarboxylic dianhydride, 3,3′,4,4′-benzophenone tetracarboxylic dianhydride, and may particularly include 3,3′,4,4′-biphenyl tetracarboxylic dianhydride.

The aromatic tetracarboxylic dianhydride may be used alone or in combination of two or more kinds thereof.

Examples of the aromatic diamine compound include aromatic diamines such as p-phenylenediamine, m-phenylenediamine, 4,4′-diaminodiphenyl methane, 4,4′-diaminodiphenyl ethane, 4,4′-diaminodiphenyl ether, 4,4′-diaminodiphenyl sulfide, 4,4′-diaminodiphenyl sulfone, 1,5-diaminonaphthalene, 3,3-dimethyl-4,4′-diaminobiphenyl, 5-amino-1-(4′-aminophenyl)-1,3,3-trimethylindane, 6-amino-1-(4′-aminophenyl)-1,3,3-trimethylindane, 4,4′-diaminobenzanilide, 3,5-diamino-3′-trifluoromethylbenzanilide, 3,5-diamino-4′-trifluoromethyl benzanilide, 3,4′-diaminodiphenyl ether, 2,7-diaminofluorene, 2,2-bis(4-aminophenyl)hexafluoropropane, 4,4′-methylene-bis(2-chloroaniline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 4,4′-diamino-2,2′-bis(trifluoromethyl)biphenyl, 2,2-bis[4-(4-aminophenoxy)phenyl]propane, 2,2-bis[4-(4-aminophenoxy)phenyl]hexafluoropropane, 1,4-bis(4-aminophenoxy)benzene, 4,4′-bis(4-aminophenoxy)-biphenyl, 1,3′-bis(4-aminophenoxy)benzene, 9,9-bis(4-aminophenyl) fluorene, 4,4′-(p-phenylene isopropylidene)bisaniline, 4,4′-(m-phenylene isopropylidene)bisaniline, 2,2′-bis[4-(4-amino-2-trifluoromethylphenoxy)phenyl]hexafluoropropane, 4,4′-bis[4-(4-amino-2-trifluoromethyl) phenoxy]-octafluorobiphenyl; aromatic diamines having two amino groups bonded to an aromatic ring such as diaminotetraphenyl thiophene and a heteroatom other than a nitrogen atom of the amino group; and the like.

Among these, specific examples of the aromatic diamine compound may include p-phenylene diamine, m-phenylene diamine, 4,4′-diaminodiphenyl methane, 4,4′-diaminodiphenyl ether, 3,4′-diaminodiphenyl ether, 4,4′-diaminodiphenyl sulfide, 4,4′-diaminodiphenyl sulfone, and may particularly include 4,4′-diaminodiphenyl ether and p-phenylene diamine.

The aromatic diamine compound may be used alone or in combination of two or more kinds thereof.

In addition, in order to adjust the handleability and mechanical properties of the obtained polyimide, for example, there is also a case where two or more kinds of aromatic tetracarboxylic dianhydride and/or aromatic diamine compounds are, for example, preferably used for copolymerization.

Examples of the combination of copolymerization include a copolymerization of an aromatic tetracarboxylic dianhydride and/or aromatic diamine compound having one aromatic ring in the chemical structure and an aromatic tetracarboxylic dianhydride and/or aromatic diamine compound having two aromatic rings in the chemical structure, a copolymerization of an aromatic tetracarboxylic dianhydride and/or diamine compound and an aromatic carboxylic acid dianhydride and/or aromatic diamine compound having a flexible linking group such as alkylene group, alkyleneoxy group, and siloxane group, or the like.

A number average molecular weight of the polyimide precursor may be equal to or more than 1,000 and equal to or less than 150,000, for example, more preferably equal to or more than 5,000 and equal to or less than 130,000, and for example, even more preferably equal to or more than 10,000 and equal to or less than 100,000.

In a case where the number average molecular weight of the polyimide precursor is within the range, a decrease in the solubility of the polyimide precursor in a solvent is suppressed, and film-forming properties are easily ensured.

A number average molecular weight of the polyimide precursor is measured by a gel permeation chromatography (GPC) method under the following measurement conditions.
Column: Tosoh TSK gel α-M (7.8 mm I.D×30 cm)
Eluent: dimethylformamide (DMF)/30 mM LiBr/60 mM phosphoric acid
Flow rate: 0.6 mL/min
Injection amount: 60 μL
Detector: differential refractive index detector (RI)

A content (concentration) of the polyimide precursor may be, for example, equal to or more than 0.1% by mass and equal to or less than 40% by mass, for example, preferably equal to or more than 0.5% by mass and equal to or less than 25% by mass, and for example, more preferably equal to or more than 1% by mass and equal to or less than 20% by mass, with respect to the entire polyimide precursor solution.

Resin Particles

As the resin particles, resin particles not dissolved in the polyimide precursor solution are used.

In the present exemplary embodiment, “not dissolved” also includes that the resin particles are dissolved in an aqueous solvent contained in the polyimide precursor solution at 25° C. within a range of 3% by mass or less.

The resin particles may be used alone or in combination of two or more.

The resin particles are not particularly limited, but are resin particles made of a resin other than polyimide.

Specific examples of the resin particles include resin particles such as vinyl-based resins represented by polystyrenes, poly(meth)acrylic acids, polyvinyl acetate, polyvinyl alcohol, polyvinyl butyral, and polyvinyl ether; condensation-type resins represented by polyesters, polyurethanes, and polyamides; hydrocarbon-based resins represented by polyethylene, polypropylene, and polybutadiene; fluorine-based resins represented by polytetrafluoroethylene and polyvinyl fluoride.

Here, (meth)acrylic acids include (meth)acrylic acid, (meth) acrylic acid ester, and (meth)acrylamide.

In addition, the resin particles may or may not be crosslinked.

In a case where the resin particles are resin particles made of a vinyl resin, the resin particles can be obtained by addition polymerization of the monomer.

Examples thereof include vinyl resin unit obtained by polymerizing a monomer such as styrenes having a styrene skeleton such as styrene, alkyl-substituted styrene (for example, α-methylstyrene, 2-methylstyrene, 3-methylstyrene, 4-methylstyrene, 2-ethylstyrene, 3-ethylstyrene, 4-ethylstyrene, and the like) and halogen-substituted styrene (for example, 2-chlorostyrene, 3-chlorostyrene, 4-chlorostyrene, and the like), and vinylnaphthalene; (meth)acrylic acid esters such as methyl(meth)acrylate, ethyl(meth)acrylate, n-propyl(meth)acrylate, n-butyl(meth)acrylate, lauryl(meth)acrylate, and 2-ethylhexyl(meth)acrylate; vinyl nitriles such as acrylonitrile and methacrylonitrile; vinyl ethers such as vinyl methyl ether and vinyl isobutyl ether; vinyl ketones such as vinyl methyl ketone, vinyl ethyl ketone, vinyl isopropenyl ketone; acids such as (meth)acrylic acid, maleic acid, cinnamic acid, fumaric acid, and vinylsulfonic acid; and bases such as ethyleneimine vinylpyridine, and vinylamine.

A vinyl-based resin may be a resin that is obtained by using one monomer among these monomers alone, or may be a resin that is a copolymer obtained by using two or more monomers.

As other monomers thereof, monofunctional monomers such as vinyl acetate, difunctional monomers such as divinyl benzene, ethylene glycol dimethacrylate, nonane diacrylate, and decanediol diacrylate, and polyfunctional monomers such as trimethylolpropane triacrylate and trimethylolpropane trimethacrylate may be used in combination.

By using the bifunctional monomer and the polyfunctional monomer in combination, crosslinked resin particles are obtained.

From a viewpoint of producibility and adaptability of a particle removal step described later, for example, the resin particles are preferably resin particles made of polystyrenes, poly(meth)acrylic acids, or polyesters, and more preferably resin particles made of polystyrene, styrene-(meth)acrylic acid copolymers, or poly (meth)acrylic acids.

Here, polystyrenes are resins containing a structural unit derived from a styrene-based monomer (a monomer having a styrene skeleton). More specifically, in a case where a sum of the structural units constituting the resin is set to 100 mol %, the polystyrenes, for example, contain the structural unit in an amount of preferably equal to or more than 30 mol %, and more preferably equal to or more than 50 mol %.

In addition, the poly(meth)acrylic acids mean a methacrylic resin and an acrylic resin, and are resins containing a structural unit derived from a (meth)acrylic monomer (a monomer having a (meth)acryloyl skeleton). More specifically, in a case where the sum of the composition in the polymer is set to 100 mol %, poly(meth)acrylic acids, for example, contain the total proportion of the structural units derived from (meth)acrylic acid and/or the structural units derived from (meth)acrylic acid ester in an amount of preferably equal to or more than 30 mol %, and more preferably equal to or more than 50 mol %.

Further, polyesters are resins obtained by polycondensing a polyvalent carboxylic acid and a polyhydric alcohol and having an ester bond in the main chain.

From a viewpoint of easily suppressing the movement of the particles by decreasing difference in a specific gravity with the solvent, for example, the resin particles are preferably resin particles made of a resin containing a structural unit derived from styrene, and in a case where a sum of the structural unit constituting the resin is set to 100 mol %, the resin particles contain the structural unit derived from styrene in an amount of for example, preferably equal to or more than 30 mol %, more preferably equal to or more than 50 mol %, even more preferably equal to or more than 80 mol %, and particularly preferably 100 mol %.

These resin particles may be used alone or in combination of two or more.

For the resin particles, for example, it is preferable that a shape of the particles is maintained in a process of producing the polyimide precursor solution according to the present exemplary embodiment, and a process of application of the polyimide precursor solution according to the present exemplary embodiment in a case of producing the polyimide film, and the drying of a coating film (before removing the resin particles). From these viewpoints, a glass transition temperature of the resin particles may be, for example, equal to or higher than 60° C., preferably equal to or higher than 70° C., and more preferably equal to or higher than 80° C.

The glass transition temperature is obtained from the DSC curve obtained by differential scanning calorimetry (DSC), and more specifically obtained from “extra glass transition start temperature” described in the method of achieving the glass transition temperature of plastics” of JIS K 7121: 1987.

The content of the resin particles may be determined depending on the use of the polyimide film, and is, for example, preferably equal to or more than 0.1% by mass and equal to or less than 15% by mass, more preferably equal to or more than 0.5% by mass and equal to or less than 15% by mass, and even more preferably equal to or more than 1% by mass and equal to or less than 15% by mass, with respect to a total mass of the polyimide precursor solution according to the present exemplary embodiment.

A volume average particle diameter of the resin particles is, for example, preferably equal to or more than 0.1 μm and equal to or less than 1.0 μm.

By setting the volume average particle diameter of the resin particles within a numerical value range of equal to or more than 0.1 μm and equal to or less than 1.0 μm, a dispersed state of the resin particles contained in the coating film becomes almost uniform in the production of the porous polyimide film, and the porosity and the independent porosity of the obtained porous polyimide film easily become high.

The volume average particle diameter of the resin particles is, for example, more preferably equal to or more than 0.120 μm and equal to or less than 0.980 μm, and even more preferably equal to or more than 0.150 μm and equal to or less than 0.950 μm.

The volume average particle diameter of the resin particles is obtained by subtracting cumulative distribution from a small particle diameter side for volume relative to the divided particle size range (channel), using particle size distribution obtained by measurement with a laser diffraction type particle size distribution measuring device (for example, the above-mentioned Coulter Counter LS13, and measuring the particle diameter that is 50% cumulative with respect to all particles as a volume average particle diameter.

Aqueous Solvent

The aqueous solvent includes water.

Examples of water include distilled water, ion-exchanged water, ultrafiltered water, pure water, and the like.

A content of water is, for example, preferably equal to or more than 50% by mass with respect to the total amount of the aqueous solvent.

By setting a content of water within the numerical value range, a boiling point of the aqueous solvent is further lowered. Therefore, the aqueous solvent is easily boiled in gaps between the polyimide precursors. With this, a larger number of pores formed by volatilization of the aqueous solvent is formed, and a structure in which the pores communicate with each other is more easily formed.

From the above, by setting the water content within the numerical value range, it becomes easy to obtain a particle-dispersed polyimide precursor solution capable of obtaining a porous polyimide film having a lower dielectric constant.

The content of water is, for example, more preferably equal to or more than 70% by mass and equal to or less than 100% by mass, and even more preferably equal to or more than 80% by mass and equal to or less than 100% by mass with respect to the entire aqueous solvent.

The aqueous solvent may contain a solvent other than water.

As the solvent other than water, for example, the solvent is preferably water-soluble. Here, water-soluble means that a target substance is dissolved in water by equal to or more than 1% by mass at 25° C.

Examples of the solvent other than water include a water-soluble organic solvent and an aprotic polar solvent.

Examples of the water-soluble organic solvent include a water-soluble ether-based solvent, a water-soluble ketone-based solvent, a water-soluble alcohol-based solvent, and the like.

The water-soluble ether-based solvent is a water-soluble solvent having an ether bond in one molecule.

Examples of the water-soluble ether-based solvent include tetrahydrofuran (THF), dioxane, trioxane, 1,2-dimethoxyethane, diethylene glycol dimethyl ether, diethylene glycol diethyl ether, and the like. Among these, the water-soluble ether-based solvent is, for example, preferably tetrahydrofuran and dioxane.

The water-soluble ketone-based solvent is a water-soluble solvent having a ketone group in one molecule. Examples of the water-soluble ketone-based solvent include acetone, methyl ethyl ketone, cyclohexanone, and the like. Among these, the water-soluble ketone-based solvent is, for example, preferably acetone.

The water-soluble alcohol-based solvent is a water-soluble solvent having an alcoholic hydroxyl group in one molecule. Examples of the water-soluble alcohol-based solvent include methanol, ethanol, 1-propanol, 2-propanol, tert-butyl alcohol, ethylene glycol, ethylene glycol monoalkyl ether, propylene glycol, propylene glycol monoalkyl ether, diethylene glycol, diethylene glycol monoalkyl ether, 1,2-propanediol, 1,3-propanediol, 1,3-butanediol, 1,4-butanediol, 2,3-butanediol, 1,5-pentanediol, 2-butene-1,4-diol, 2-methyl-2,4-pentanediol, glycerin, 2-ethyl-2-hydroxymethyl-1,3-propanediol, 1,2,6-hexanetriol, and the like. Among these, the water-soluble alcohol-based solvent is, for example, preferably methanol, ethanol, 2-propanol, ethylene glycol, ethylene glycol monoalkyl ether, propylene glycol, propylene glycol monoalkyl ether, diethylene glycol, diethylene glycol monoalkyl ether, and the like.

Examples of the aprotic polar solvent include a solvent having a boiling point of equal to or higher than 150° C. and equal to or lower than 300° C. and a dipole moment of equal to or more than 3.0 D and equal to or less than 5.0 D.

Specific examples of the aprotic polar solvent include N-methyl-2-pyrrolidone (NMP), N,N-dimethylformamide (DMF), N,N-dimethylacetamide (DMAc), dimethyl sulfoxide (DMSO), hexamethylene phosphoramide (HMPA), N-methylcaprolactam, N-acetyl-2-pyrrolidone, 1,3-dimethyl-2-imidazolidinone (DMI), N,N′-dimethylpropyleneurea, tetramethylurea, trimethyl phosphate, triethyl phosphate, and the like.

The content of the solvent other than water contained in the aqueous solvent is, for example, equal to or more than 0% by mass and equal to or less than 30% by mass, and particularly preferably equal to or more than 0% by mass and equal to or less than 20% by mass with respect to the entire aqueous solvent.

Amine Compound

The polyimide precursor solution according to the present exemplary embodiment contains an amine compound having a boiling point of equal to or higher than 250° C. and equal to or lower than 300° C.

Here, the amine compound having a boiling point of equal to or higher than 250° C. and equal to or lower than 300° C. is also simply referred to as “specific amine compound” below.

In addition, the amine compound means a compound having one or more amino groups in one molecule.

A specific amine compound is a compound which makes the polyimide precursor (carboxy group thereof) into an amine salt, enhances the solubility thereof in the aqueous solvent thereof, and also functions as an imidization accelerator.

The specific amine compound may be, for example, a compound excluding the diamine compound that is a raw material of the polyimide precursor.

The specific amine compound may be either a chain or cyclic (monocyclic or polycyclic)amine compound according to the classification of the skeleton. In addition, the specific amine compound may be either an aliphatic or aromatic amine compound according to the classification of the skeleton, but for example, preferably an aliphatic amine compound. The specific amine compound may be an amine compound having a functional group having a hetero element in the skeleton or as a substituent.

Examples of the specific amine compound include a primary amine compound, a secondary amine compound, and a tertiary amine compound.

Here, in a case of a divalent or higher amine compound, there is a case where the number of substituents of an amino group contained in one-molecule amine compound is different. In this case, it is determined to any of which the compound corresponds among a primary amine compound, a secondary amine compound, or a tertiary amine compound based on the amino group having the largest number of substituents.

Specifically, for example, in the case of an amine compound containing an amino group having one substituent and an amino group having two substituents in one molecule, the compound corresponds to a secondary amine compound.

Specific examples of the primary amine compound include 1-dodecylamine (boiling point: 259° C.), 1-tridecanamine (boiling point: 265° C.), 1-tetradecylamine (boiling point: 291° C.), and the like.

Examples of the secondary amine compound include dialkylamine, secondary amino alcohol, and the like.

Here, the dialkylamine is a compound having an amino group to which two alkyl groups are bonded.

In addition, the secondary amino alcohol refers to a secondary amine compound having a hydroxy group.

Specific examples of the secondary amine compound include di-n-heptylamine (boiling point: boiling point at 148° C./pressure of 2.0 KPa), di-n-octylamine (boiling point: 298° C.), diisopropanolamine (boiling point: 250° C.), and the like.

Examples of the tertiary amine compound include an amine compound having a heterocyclic structure containing nitrogen (hereinafter, referred to as “nitrogen-containing heterocyclic amine compound”), trialkylamine, a tertiary amino alcohol, and the like.

Here, the trialkylamine is a compound having an amino group to which three alkyl groups are bonded.

In addition, the tertiary amino alcohol refers to a tertiary amine compound having a hydroxy group.

As the tertiary amine compound, for example, an amine compound having a nitrogen-containing heterocyclic structure (hereinafter, referred to as “nitrogen-containing heterocyclic amine compound”) is preferable.

Examples of the nitrogen-containing heterocyclic amine compound include isoquinolins (amine compound having an isoquinolin skeleton), pyridines (amine compound having a pyridine skeleton), pyrimidines (amine compound having a pyrimidine skeleton), pyrazines (amine compound having a pyrazine skeleton), piperazines (amine compound having a piperazine skeleton), triazines (amine compound having a triazine skeleton), imidazoles (amine compound having an imidazole skeleton), morpholines (amine compound having a morpholine skeleton), polyaniline, polypyridine, polyamine, and the like.

Examples of the nitrogen-containing heterocyclic amine compound include morpholins, pyridines, piperidines, imidazoles, and the like.

Specific examples of the nitrogen-containing heterocyclic amine compound include 2-ethyl-4-methylimidazole (boiling point: 293° C.), 4-methylimidazole (boiling point: 263° C.), imidazole (boiling point: 257° C.), 2-methylimidazole (boiling point: 267° C.), and the like.

Examples of the specific amine compound is, for example, preferably at least one selected from the group consisting of a secondary amine compound and a tertiary amine compound.

By selecting at least one selected from the group consisting of the secondary amine compound and the tertiary amine compound, as the specific amine compound, the solubility of the polyimide precursor in the solvent is easily increased. Along with this, in the production of the porous polyimide film, the dispersed state of the resin particles contained in the coating film becomes almost uniform, and the porosity and the independent porosity of the obtained porous polyimide film easily become high.

From a viewpoint that the solubility of the polyimide precursor in a solvent is easily further increased and a polyimide precursor capable of obtaining a porous polyimide film having a high porosity and a high independent porosity is made, for example, it is preferable that the secondary amine compound is at least one selected from the group consisting of dialkylamine and secondary amine alcohol, and the tertiary amine compound is at least one selected from the group consisting of trialkylamine, tertiary amino alcohol, and imidazoles.

From the viewpoint that a polyimide precursor capable of obtaining a porous polyimide film having a high porosity and a high independent porosity is made, as the specific amine compound, for example, it is preferable to use an amine compound having a boiling point of equal to or higher than 255° C. and equal to or lower than 295° C., it is more preferable to use an amine compound having a boiling point of equal to or higher than 260° C. and equal to or lower than 290° C., and it is even more preferable to use an amine compound having a boiling point of equal to or higher than 265° C. and equal to or lower than 285° C.

The specific amine compound may be, for example, contained in an amount of equal to or more than 50 mol % and equal to or less than 500 mol %, preferably equal to or more than 80 mol % and equal to or less than 250 mol %, and even more preferably equal to or more than 90 mol % and equal to or less than 200 mol %, with respect to the carboxy group (—COOH) of the polyimide precursor in the polyimide precursor solution.

The specific amine compound may be used alone or in combination of two or more kinds thereof.

Other Additives

The polyimide precursor solution according to the present exemplary embodiment may contain a catalyst for promoting the imidization reaction, a leveling material for improving film forming quality, or the like.

As the catalyst for promoting the imidization reaction, a dehydrating agent such as an acid anhydride, an acid catalyst such as a phenol derivative, a sulfonic acid derivative, a benzoic acid derivative, and the like may be used.

In addition, depending on the purpose of use, for example, the polyimide precursor solution may contain a conductive material (for example, conductive properties (for example, a volume resistivity of less than 10⁷ Ω·cm) or semi-conductive properties (for example, a volume resistivity of equal to or more than 10⁷ Ω·cm and equal to or less than 10¹³ Ω·cm)) added for imparting conductive properties.

Examples of a conductive agent include carbon black (for example, acidic carbon black having a pH of equal to or less than 5.0); metal (for example, aluminum, nickel, or the like); metal oxide (for example, yttrium oxide, tin oxide, and the like); ion conductive substance (for example, potassium titanate, LiCl, and the like); and the like. These conductive materials may be used alone or in combination of two or more kinds thereof.

Volume of Each Component

A ratio of a volume of the resin particles to a volume of the specific amine compound (volume of resin particles/volume of amine compound) is equal to or more than 0.22 and equal to or less than 0.61.

From the viewpoint that a polyimide precursor capable of obtaining a porous polyimide film having a high porosity and a high independent porosity is made, the ratio of the volume of the resin particles to the volume of the specific amine compound (volume of resin particles/volume of amine compound) is, for example, preferably equal to or more than 0.24 and equal to or less than 0.59, more preferably equal to or more than 0.26 and equal to or less than 0.57, and even more preferably equal to or more than 0.28 and equal to or less than 0.55.

A proportion of the volume of the resin particles is, for example, preferably equal to or more than 20% by volume and equal to or less than 40% by volume, more preferably equal to or more than 22% by volume and equal to or less than 38% by volume, and even more preferably equal to or more than 24% by volume and equal to or less than 36% by volume with respect to a total volume of the polyimide precursor and the resin particles.

By setting the proportion of the volume of the resin particles to the total volume of the polyimide precursor and the resin particles to equal to or more than 20% by volume, it becomes easy to obtain a polyimide precursor solution capable of obtaining a porous polyimide film having a high porosity.

By setting the proportion of the volume of the resin particles to the total volume of the polyimide precursor and the resin particles to equal to or less than 40% by volume, it becomes easy to obtain a polyimide precursor solution capable of obtaining a porous polyimide film having a high independent porosity.

From the viewpoint that a polyimide precursor capable of obtaining a porous polyimide film having a high porosity and a high independent porosity is made, the proportion of the volume of the resin particles is, for example, preferably equal to or more than 0.5% by volume and equal to or less than 20.0% by volume, more preferably equal to or more than 0.7% by volume and equal to or less than 18.0% by volume, and even more preferably equal to or more than 1.0% by volume and equal to or less than 15.0% by volume, with respect to the total volume of the polyimide precursor solution.

The volume of the specific amine compound is measured as follows.

Examples of a method of obtaining the volume of the specific amine compound contained in the polyimide precursor solution include a method of distilling a filtrate obtained by filtering a polyimide precursor solution to remove the resin particles, recovering the fraction of the specific amine compound, and obtaining a volume of the recovered fraction.

In the measurement of the volume of the recovered fraction, a graduated cylinder can be used.

The measurement of volume of the resin particles is measured as follows.

Examples of a method of obtaining the volume of the resin particles contained in the polyimide precursor solution include a method of recovering a filtrate obtained by filtering the polyimide precursor solution to remove the resin particles, obtaining a difference (volume of polyimide precursor solution before filtration−volume of filtrate after filtration) between a volume of the polyimide precursor solution before filtration and a volume of the filtrate after filtration, and using the obtained value as the volume of the resin particles.

In the measurement of the volume of the polyimide precursor solution before filtration and the filtrate after filtration, a graduated cylinder can be used.

The measurement of the volume of the polyimide precursor is performed as follows.

Examples of a method of obtaining a volume of the polyimide precursor contained in the polyimide precursor solution include a method of applying a polyimide precursor solution on a base material, measuring a volume of a dry film dried at 200° C. for 1 hour with a laser volume meter (for example, manufactured by Keyence, product name VL-570 can be used), calculating a difference (volume of dry film−volume of resin particles) between the volume of the obtained dry film and the volume of the resin particles obtained by the above-mentioned method, and using the obtained value as the volume of the polyimide precursor.

The “volume of the resin particles” used to calculate the volume of the polyimide precursor is a volume of the resin particles contained in the same amount of the polyimide precursor solution as the polyimide precursor solution applied onto the base material.

Method for Producing Porous Polyimide Film

Hereinafter, an example of a production method in the porous polyimide film according to the present exemplary embodiment will be described.

The method for producing a porous polyimide film according to the present exemplary embodiment has, for example, the following steps.

A first step of applying a polyimide precursor solution to form a coating film, drying the coating film, and forming a film containing a polyimide precursor and resin particles.

A second step of heating the film, imidizing the polyimide precursor to form a polyimide film, the second step including a treatment of removing the resin particles.

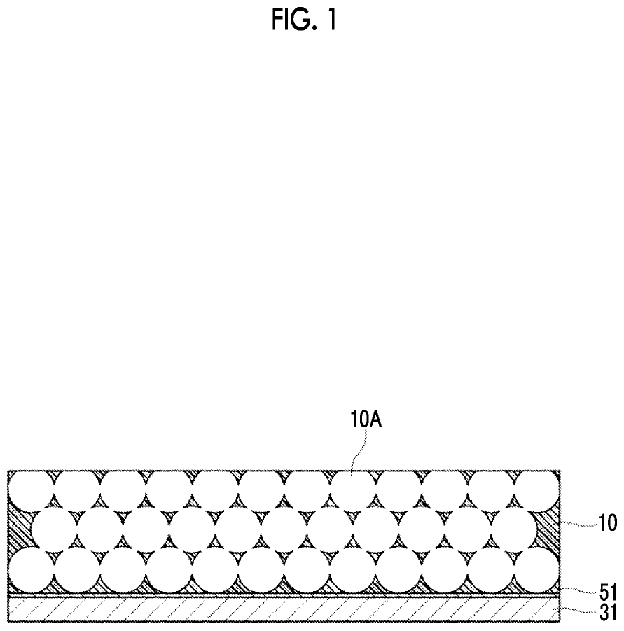

In the description of the production method, the same constituent portions are designated by the same reference numerals in FIG. 1 to be referred to. In the reference numerals in FIG. 1, 31 represents a substrate, 51 represents a release layer, 10A represents a pore, and 10 represents a porous polyimide film.

First Step

In the first step, first, a polyimide precursor solution is prepared.

Examples of the method of preparing a polyimide precursor solution according to the present exemplary embodiment include a method according to (i) or (ii) below.

(i) A method of preparing a polyimide precursor solution before dispersing resin particles, and then mixing and dispersing resin particles (powder or organic solvent dispersion)

(ii) A method of synthesizing a polyimide precursor in an organic solvent dispersion of resin particles

(i) A method of preparing a polyimide precursor solution before dispersing resin particles, and then mixing and dispersing the resin particles

First, examples of the method of preparing a polyimide precursor solution before dispersing resin particles include a method of obtaining a polyimide precursor solution before dispersing resin particles by polymerizing an aromatic tetracarboxylic dianhydride and a diamine compound in an organic solvent using a known method to produce a resin (polyimide precursor).

Next, the polyimide precursor solution before dispersing the obtained resin particles is mixed with resin particles, described in the section of resin particles, and the mixture is agitated. Alternatively, the resin particles are redispersed in an organic solvent that does not dissolve the resin particles (either alone or in a mixed solvent), and then may be mixed and agitated with the polyimide precursor solution that disperses the resin particles.

The mixing, agitating, and dispersing methods are not particularly limited. In addition, in order to improve the dispersibility of the resin particles, a known nonionic or ionic surfactant may be added.

(ii) A method of synthesizing a polyimide precursor in an organic solvent dispersion of resin particles

First, a solution, in which resin particles are dispersed in an organic solvent in which the resin particles are not dissolved and the polyimide precursor is dissolved, is prepared. Next, a polyimide precursor solution is obtained by polymerizing the aromatic tetracarboxylic dianhydride and the diamine compound in the solution to produce a resin (polyimide precursor).

The polyimide precursor solution obtained by the method is applied onto a substrate to form a coating film containing the polyimide precursor solution. Then, the coating film formed on the substrate is dried to form a film containing the polyimide precursor and the resin particles.

The substrate on which the polyimide precursor solution is applied is not particularly limited. Examples of the substrate include resin substrates such as polystyrene and polyethylene terephthalate; glass substrates; ceramic substrates; metal substrates such as iron and stainless steel (SUS); composite material substrates in which these materials are combined; and the like. In addition, as necessary, the substrate may be, for example, provided with a release layer by performing a release treatment with a silicone-based or fluorine-based release agent.

The method of applying the polyimide precursor solution on the substrate is not particularly limited. For example, various methods such as a spray coating method, a rotary coating method, a roll coating method, a bar coating method, a slit die coating method, and an inkjet coating method can be exemplified.

The applying amount of the polyimide precursor solution to obtain a coating film containing the polyimide precursor solution may be set to an amount capable of obtaining a predetermined film thickness.

After forming the coating film containing the polyimide precursor solution, the coating film dried to form a film containing the polyimide precursor and the resin particles. Specifically, the coating film containing a polyimide precursor solution is dried by a method such as heat drying, natural drying, and vacuum drying to form a film. More specifically, the film is formed by drying the coating film such that the solvent remaining in the film is equal to or less than 50%, and for example, preferably equal to or less than 30% with respect to the solid content of the film.

Second Step

The second step is a step of heating the film containing the polyimide precursor solution and the resin particles obtained in the first step, and imidizing the polyimide precursor to form a polyimide film. The second step includes a treatment of removing resin particles. A porous polyimide film is obtained through the treatment of removing the resin particles.

In the second step, in the step of forming the polyimide film, specifically, the film containing the polyimide precursor and the resin particles obtained in the first step is heated to proceed imidization, and further heated to form a polyimide film with advanced imidization. As imidization proceeds, and the imidization rate increases, it becomes more difficult to dissolve in an organic solvent.

Then, in the second step, a treatment of removing resin particles is performed. The resin particles may be removed in the process of heating the film to imidize the polyimide precursor, or may be removed from the polyimide film after the imidization is completed (after imidization).

In the present exemplary embodiment, the process of imidizing the polyimide precursor refers to a process of heating the film containing the polyimide precursor and the resin particles obtained in the first step to proceed imidization, and making the polyimide precursor to be in a state before the polyimide film is formed after imidization is completed.

The process of removing the resin particles is, for example, preferably performed in a case where the imidization rate of the polyimide precursor in the polyimide film is equal to or more than 10% in the process of imidizing the polyimide precursor, from a viewpoint of removability of the resin particles and the like. In a case where the imidization rate is equal to or more than 10%, the shape of the film is easily maintained.

Next, a treatment of removing resin particles will be described.

Examples of the treatment of removing the resin particles include a method of removing resin particles by heating, a method of removing resin particles with an organic solvent that dissolves the resin particles, a method of removing resin particles by decomposition with a laser, and the like. Among these, for example, a method of removing resin particles by heating and a method of removing resin particles with an organic solvent that dissolves the resin particles are preferable.

As the method of removing by heating, for example, in the process of imidizing the polyimide precursor, the resin particles may be removed by decomposing the resin particles by heating for proceeding the imidization. In this case, from a viewpoint that there is no operation of removing the resin particles with a solvent, the method is useful for reducing the steps.

Examples of the method of removing resin particles with an organic solvent that dissolves the resin particles include a method of removing resin particles by allowing the resin particles to contact with the organic solvent (for example, immersing in a solvent) that dissolves the resin particles, and dissolving the resin particles. In a case where the resin particles are immersed in the solvent in this state, the method is, for example, preferable in that the dissolution efficiency of the resin particles is increased.

The organic solvent that dissolves the resin particles for removing the resin particles is not particularly limited as long as the organic solvent does not dissolve the polyimide film before imidization is completed and the polyimide film after imidization is completed, and the resin particles are soluble therein. Examples of the organic solvent include ethers such as tetrahydrofuran (THF); aromatics such as toluene; ketones such as acetone; esters such as ethyl acetate; and the like.

In a case where the resin particles are removed by dissolution removal to make a polyimide film porous, resin particles that are soluble in a general-purpose solvent such as tetrahydrofuran, acetone, toluene, and ethyl acetate are, for example, preferable. Water can also be used depending on the resin particles and the polyimide precursor used.

In addition, in a case where the resin particles are removed by heating to make a polyimide film porous, the resin particles are not decomposed at a drying temperature after applying, but are thermally decomposed at a temperature for imidizing the film of the polyimide precursor. From this viewpoint, the thermal decomposition start temperature of the resin particles may be, for example, equal to or higher than 150° C. and equal to or lower than 320° C., preferably equal to or higher than 180° C. and equal to or lower than 300° C., and more preferably equal to or higher than 200° C. and equal to or lower than 280° C.

In the second step, the heating method for heating the film obtained in the first step to proceed imidization to obtain a polyimide film is not particularly limited. For example, a method of heating in two stages is exemplified. In the case of heating in two stages, specifically, the following heating conditions are exemplified.

As the heating conditions of the first stage, for example, it is desirable to set the temperature such that the shape of the resin particles is maintained. Specifically, for example, the temperature may be in a range of equal to or higher than 50° C. and equal to or lower than 150° C., and is for example, preferably in a range of equal to or higher than 60° C. and equal to or lower than 140° C. In addition, the heating time may be, for example, in a range of equal to or more than 10 minutes and equal to or less than 60 minutes. The higher the heating temperature, the shorter the heating time may be.

Examples of the heating conditions of the second stage include heating under the condition of equal to or higher than 150° C. and equal to or lower than 450° C. (for example, preferably, equal to or higher than 200° C. and equal to or lower than 430° C.) for equal to or more than 20 minutes and equal to or less than 120 minutes. By setting the heating conditions in this range, the imidization reaction further proceeds and a polyimide film can be formed. For example, during the heating reaction, the temperature may be increased in stages or gradually at a constant rate before the final temperature of heating is reached.

The heating conditions are not limited to the two-stage heating method, and for example, a one-stage heating method may be adopted. In a case of the one-stage heating method, for example, the imidization may be completed only by the heating conditions shown in the second stage.

In the second step, a treatment for exposing the resin particles may be performed to expose the resin particles. In the second step, the treatment for exposing the resin particles is, for example, preferably performed during a process of imidizing the polyimide precursor, or after the imidization, and before the treatment of removing the resin particles.

In this case, for example, in a case where a film is formed on a substrate using a polyimide precursor solution, the polyimide precursor solution is applied onto the substrate to form a coating film in which the resin particles are embedded. Next, the coating film is dried to form a film containing a polyimide precursor and resin particles. The film formed by this method is in a state in which resin particles are embedded. The film may be subjected to a process of imidizing the polyimide precursor or a treatment of exposing the resin particles from the polyimide film after the imidization is completed (after imidization) before performing a treatment of removing the resin particles.

In the second step, the treatment of exposing the resin particles may be performed, for example, in a case where the polyimide film is in the following state.

In a case where a treatment of exposing resin particles is performed when the imidization rate of the polyimide precursor in the polyimide film is less than 10% (that is, in a state in which the polyimide film can be dissolved in the solvent), examples of the treatment of exposing the resin particles embedded in the polyimide film include a wiping treatment, a treatment of immersing the resin particles in a solvent, and the like. The solvent used at this time may be the same as or different from the solvent used for the polyimide precursor solution according to the present exemplary embodiment.

In addition, in a case where a treatment of exposing resin particles is performed, in a case where an imidization rate of the polyimide precursor in the polyimide film is equal to or more than 10% (that is, in a state where it is hard to be dissolved in water or an organic solvent), and in a state of being a polyimide film in which imidization has been completed, a method of exposing resin particles by mechanically cutting with a tool such as sandpaper, a method of exposing resin particles by decomposing with a laser, and the like are exemplified.

For example, in the case of mechanical cutting, a portion of the resin particles present in a region (that is, a region on a side separated from a substrate of the resin particles) in an upper portion of the resin particles embedded in the polyimide film is cut together with the polyimide film present in the upper portion of the resin particles, and the cut resin particles are exposed from a surface of the polyimide film.

Thereafter, the resin particles are removed from the polyimide film to which the resin particles are exposed by the above-mentioned removal treatment of the resin particles. Then, a porous polyimide film from which the resin particles have been removed is obtained (refer to FIG. 1).

In the above description, a production step of a porous polyimide film subjected to a treatment of exposing the resin particles is shown in the second step, but a treatment of exposing the resin particles may be performed in the first step. In this case, in a process of drying to form a film after obtaining a coating film in the first step, there may be a state in which the resin particles are exposed by performing a treatment of exposing the resin particles.

For example, in the process of drying a coating film to form a film containing a polyimide precursor and resin particles after obtaining a coating film containing a polyimide precursor solution, as described above, the film is in a state in which the polyimide precursor can be dissolved in a solvent. In a case where the film is in this state, for example, the resin particles can be exposed by a wiping treatment or a treatment of immersing the resin particles in a solvent. Specifically, the polyimide precursor solution present in the region of equal to or more than a thickness of a resin particle layer is removed by, for example, performing a treatment of exposing resin particles by wiping the polyimide precursor solution present in the region of equal to or more than the thickness of the resin particle layer with a solvent. Then, the resin particles present in the region on the upper portion of the resin particle layer (that is, the region on the side separated from the substrate of the resin particle layer) are exposed from the surface of the film.

In the second step, the substrate for forming the film used in the first step may be peeled off when the film becomes dry, may be peeled off when the polyimide precursor in the polyimide film comes into a state of being hard to be dissolved in an organic solvent, and may be peeled off when imidization is completed and the film is formed.

Through the above steps, a porous polyimide film is obtained. Then, the porous polyimide film may be post-processed.

Here, the imidization rate of the polyimide precursor will be described.

Examples of a partially imidized polyimide precursor include precursors of a structure having a repeating unit represented by General Formula (V-1), General Formula (V-2), and General Formula (V-3).

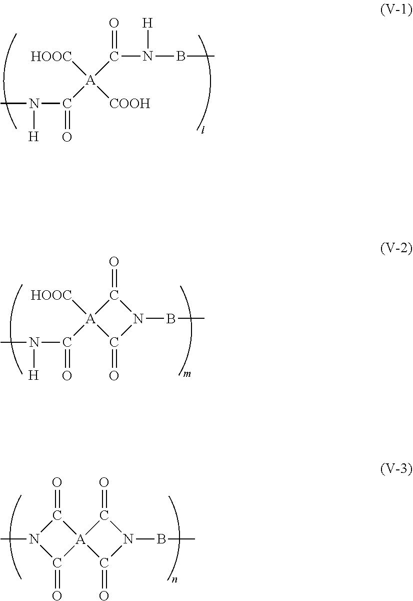

In General Formula (V-1), General Formula (V-2), and General Formula (V-3), A and B are synonymous with A and B in Formula (I). l represents an integer of equal to or more than 1, and m and n each independently represent 0 or an integer of equal to or more than 1.

The imidization rate of the polyimide precursor represents a proportion of the number of imide-ring closure bonds (2n+m) to the total number of bonds (2l+2m+2n) in the bonds of the polyimide precursor (reaction portion of aromatic tetracarboxylic dianhydride and aromatic diamine compound). That is, the imidization rate of the polyimide precursor is represented by “(2n+m)/(2l+2m+2n)”.

The imidization rate (value of “(2n+m)/(2l+2m+2n)”) of the polyimide precursor is measured by the following method.

Measurement of imidization rate of polyimide precursor

Preparation of Polyimide Precursor Sample

(i) A polyimide precursor composition to be measured is applied onto a silicon wafer in a range of a film thickness of equal to or more than 1 μm and equal to or less than 10 μm to prepare a coating film sample.

(ii) The coating film sample is immersed in tetrahydrofuran (THF) for 20 minutes to replace the solvent in the coating film sample with tetrahydrofuran (THF). The solvent to be immersed is not limited to THF, and can be selected from a solvent that does not dissolve the polyimide precursor and can be mixed with a solvent component contained in the polyimide precursor solution. Specifically, alcohol solvents such as methanol and ethanol, and ether compounds such as dioxane are used.

(iii) The coating film sample is taken out from the THF, and N₂ gas is blown to the THF adhered to a surface of the coating film sample to remove THF. Under a reduced pressure of equal to or less than 10 mmHg, the coating film sample is treated in a range of equal to or more than 5° C. and equal to or less than 25° C. for equal to or more than 12 hours, and dried to prepare a polyimide precursor sample.

Preparation of 100% Imidized Standard Sample

(iv) In the same manner as in (i), a polyimide precursor solution to be measured is applied onto a silicon wafer to prepare a coating film sample.

(v) The coating film sample is heated at 380° C. for 60 minutes to perform an imidization reaction to prepare a 100% imidized standard sample.

Measurement and Analysis

(vi) Using a Fourier transform infrared spectrophotometer (FT-730 manufactured by Horiba Ltd.), the infrared absorption spectra of the 100% imidized standard sample and the polyimide precursor sample are measured. A ratio I′ (100) of an absorption peak derived from an imide bond in the vicinity of 1780 cm⁻¹ (Ab′(1780 cm⁻¹) to an absorption peak derived from an aromatic ring in the vicinity of 1500 cm⁻¹ (Ab′(1500 cm⁻¹)) of the 100% imidized standard sample is obtained.

(vii) Similarly, the polyimide precursor sample is measured, and a ratio I(x) of an absorption peak derived from the imide bond in the vicinity of 1780 cm⁻¹ (Ab(1780 cm⁻¹)) to the absorption peak derived from the aromatic ring in the vicinity of 1500 cm-1 (Ab(1500 cm⁻¹)) is obtained.

Then, each of the measured absorption peaks I′(100) and I(x) are used to calculate the imidization rate of the polyimide precursor based on the following Formulas.

imidization rate of polyimide precursor=I(x)/I′(100) Formula:

I′(100)=(Ab′(1780 cm⁻¹))/(Ab′(1500 cm⁻¹)) Formula:

I(x)=(Ab(1780 cm⁻¹))/(Ab(1500 cm⁻¹)) Formula:

The measurement of the imidization rate of this polyimide precursor is applied to the measurement of the imidization rate of the aromatic polyimide precursor. In a case of measuring the imidization rate of an aliphatic polyimide precursor, a peak derived from a structure that does not change before and after the imidization reaction is used as an internal standard peak, instead of the absorption peak of the aromatic ring.

Porous Polyimide Film

Hereinafter, the porous polyimide film of the present exemplary embodiment will be described.

Independent Porosity and Porosity

The porous polyimide film, for example, preferably has an independent porosity of equal to or more than 40% by volume and equal to or less than 60% by volume, and for example, preferably has a porosity of equal to or more than 40% by volume and equal to or less than 60% by volume.

By setting the independent porosity and the porosity within the numerical value ranges, it is easy to obtain a porous polyimide film having a high porosity and a high independent porosity.

The independent porosity is a proportion of a volume of independent pores (pores that do not communicate with a surface of the porous polyimide film and exist inside the porous polyimide film) to a volume of the pores in the porous polyimide film.

Here, communication means that the fluid is connected so that the fluid can flow.

The porous polyimide film, for example, preferably has an independent porosity of equal to or more than 42% by volume and equal to or less than 58% by volume more preferably has an independent porosity of equal to or more than 44% by volume and equal to or less than 56% by volume, and even more preferably has an independent porosity of equal to or more than 46% by volume and equal to or less than 54% by volume.

The independent porosity is measured as follows.

The independent porosity of the porous polyimide film is a value obtained by subtracting a communication porosity described later from a porosity described later (that is, porosity−communication porosity=independent porosity).

The porosity is measured by the method described later.

A procedure for measuring the communication porosity will be described below.

A mass of the porous polyimide film to be measured is measured, and the obtained value is denoted as a measurement value A (unit is g). The porous polyimide film of which mass has been measured is submerged in water (4° C.) and then allowed to stand for 60 minutes. Then, the porous polyimide film is taken out from water, the mass is measured, and the obtained value is denoted as a measurement value B (unit is g). Then, a mass C (unit is g) of water held on the porous polyimide film is calculated by subtracting the measurement value A from the measurement value B (that is, the measurement value B−measurement value A). Since the density of water at 4° C. is about 1 g/cm³, the obtained mass is defined as a volume of the communication pores contained in the porous polyimide film (the unit is cm³).

Then, by substituting the volume of the communication pores contained in the porous polyimide film and the volume of the entire porous polyimide film including the pores into the following formula, the communication porosity (unit is t by volume) is calculated.

[volume (cm³) of communication pores contained in the porous polyimide film]+[volume (cm³) of entire porous polyimide film including pores]×100=Communication porosity (% by volume) Formula:

The porous polyimide film has, for example, preferably has a porosity of equal to or more than 42% by volume and equal to or less than 58% by volume, more preferably has a porosity of equal to or more than 44% by volume and equal to or less than 56% by volume, and even more preferably has a porosity of equal to or more than 46% by volume and equal to or less than 54% by volume.

Porosity is measured as follows.

The porosity of the porous polyimide film according to the present exemplary embodiment is a value obtained from the apparent density and a true density of the porous polyimide film. The apparent density is a value obtained by dividing the mass (g) of the porous polyimide film by the volume (cm³) of the entire porous polyimide film including the pores. The true density p is a value obtained by dividing the mass (g) of the porous polyimide film by the volume (cm³) of the porous polyimide film excluding the pores. The porosity of the porous polyimide film is calculated by the following formula.

Porosity (% by volume)={1−(d/ρ)}×100=[1−{(w/t)/ρ)}]×100 (Formula)

d: Apparent density of porous polyimide film (g/cm³)

ρ: True density of porous polyimide film (g/cm³)

w: Weight per unit area of porous polyimide film (g/m²)

t: Thickness of porous polyimide film (μm)

Pore

A shape of the pores is, for example, preferably a spherical shape or a shape close to a spherical shape. In addition, the pores are, preferably not connected to each other.

An average value of the pore size is not particularly limited, but may be in a range of equal to or more than 10 nm and equal to or less than 2500 nm, for example, more preferably in a range of equal to or more than 50 nm and equal to or less than 2000 nm, preferably in a range of equal to or more than 100 nm or more and equal to or less than 1500 nm or less, and more preferably in a range of equal to or more than 150 nm and equal to or less than 1000 nm.

The average value of the pore size, a maximum value of the pore size, and a minimum value of the pore size are values observed and measured by a scanning electron microscope (SEM). Specifically, first, a porous polyimide film is cut out and a sample for measurement is prepared. Then, the sample for measurement is observed and measured by VE SEM manufactured by KEYENCE Corporation using image processing software provided as a standard equipment. Observation and measurement are performed on 100 pieces of each of the pore portions in the cross section of the sample for measurement, and each of the minimum diameter and the maximum diameter are obtained. Then, the arithmetic mean value of the maximum diameters of the 100 pieces of measured pores is denoted as an average value of the pore sizes.

Film Thickness

A film thickness of the porous polyimide film according to the present exemplary embodiment is not particularly limited, may be selected depending on the use, and may be, for example, equal to or more than 10 μm and equal to or less than 1000 μm. For example, the film thickness may be equal to or more than 20 μm, equal to or more than 30 μm, equal to or less than 500 μm, or equal to or less than 400 μm.

Relative Dielectric Constant

A relative dielectric constant of the porous polyimide film at 1 MHz is, for example, preferably equal to or less than 2.5. The relative dielectric constant is, for example, more preferably equal to or less than 1.5, and for example, even more preferably equal to or less than 1.4. A lower limit of the relative dielectric constant is not particularly specified, but is, for example, preferably larger than 1, which is the relative dielectric constant of air.

For the relative dielectric constant at 1 MHz, the capacitance and loss at a frequency of 1 GHz are measured by an LCR meter by a parallel plate method. In addition, the film thickness is measured at a room temperature of 23±2° C. using a micro-thickening instrument KBM (trade name) manufactured by Toyo Seiki Co., Ltd., and the relative dielectric constant is calculated from these.

Measurement is performed by using a test piece (8 mm wide×8 mm long) of an opposing parallel plate of the porous polyimide film with an LCR meter (ZM2372, manufactured by NF Circuit Design Block Co., Ltd.) as a measuring device.

Use of Porous Polyimide Film

Examples of use to which the porous polyimide film according to the present exemplary embodiment is applied include low dielectric constant materials; heat insulating materials; and the like.

For the use of the porous polyimide film according to the present exemplary embodiment, for example, a low dielectric constant material is appropriate, and an insulating film is particularly appropriate.

In a case where the porous polyimide film according to the present exemplary embodiment is provided on a surface of a conductor as an insulating film, the porous polyimide film is an insulating film having a low the dielectric constant and suppressing corrosion of the conductor. The reason is presumed as follows.

The porous polyimide film according to the present exemplary embodiment has a high porosity. Therefore, the dielectric constant easily becomes low. In addition, the porous polyimide film according to the present exemplary embodiment has a high independent porosity. That is, in the porous polyimide film according to the present exemplary embodiment, the proportion of the pores communicating with each other is low. Therefore, in a case where the porous polyimide film according to the present exemplary embodiment is provided on the surface of the conductor, it becomes difficult for outside air or the like to reach the surface of the conductor through the inside of the pores. With this, the corrosion of the conductor is easily suppressed.

From the above, it is presumed that the porous polyimide film according to the present exemplary embodiment is an insulating film having a low dielectric constant and suppressing corrosion of the conductor.

Insulated Wire

The insulated wire according to the present exemplary embodiment has a conductor and a porous polyimide film on a surface of the conductor.

Conductor

A material of the conductor is not particularly limited, and materials used as conductors can be widely used. Examples of the material of the conductor include metals such as copper, copper alloy, and aluminum.

A shape of the conductor is not particularly limited.

A thickness of the conductor is not particularly limited, and examples thereof include a range of equal to or more than 0.1 mm and equal to or less than 5.0 mm.

The thickness of the conductor means a long diameter in a cross section perpendicular to a longitudinal direction of the conductor.

Here, the “long diameter in a cross section” means a length of the longest line segment inscribed in the contour line of the cross section perpendicular to the longitudinal direction of the conductor.

Porous Polyimide Film on Surface of Conductor

Here, the porous polyimide film according to the present exemplary embodiment is applied to the porous polyimide film on the surface of the conductor.

The porous polyimide film according to the present exemplary embodiment has a high porosity. Therefore, the dielectric constant becomes low and the insulating properties easily become high. In addition, since the porous polyimide film according to the present exemplary embodiment has a high independent porosity, it is difficult for outside air or the like to reach the surface of the conductor through the inside of the pores. With this, the film (porous polyimide film on the surface of the conductor) has high insulating properties, and it becomes easy to obtain an insulated wire in which corrosion of the conductor is suppressed.

Method for Producing Insulated Wire

As a method for producing the insulated wire, the same method as the method for producing the porous polyimide film can be used. Specifically, in the method for producing a porous polyimide film, it is possible to produce an insulated wire in the same manner as in the method for producing a porous polyimide film, except that a conductor is used instead of the substrate.

In addition, examples of the method for producing an insulated wire also include a method of winding a porous polyimide film produced by the method for producing a porous polyimide film around a conductor.

Use of Insulated Wire

The insulated wire according to the present exemplary embodiment has a low dielectric constant and suppresses corrosion of the conductor. The reason for this is that the porous polyimide film according to the present exemplary embodiment is provided on the surface of the conductor.

Therefore, the insulated wire according to the present exemplary embodiment can be used as an insulated wire for a motor used in a state where a high voltage is applied.

### EXAMPLES

Examples will be described below, but the present invention is not limited to these examples. In the following description, unless otherwise specified, “parts” and “%” are all based on mass.

Preparation of Resin Particle Dispersion

Preparation of PSt-1

670 parts by mass of styrene, 17.0 parts by mass of surfactant Dowfax2A1 (47% solution, manufactured by Dow Chemical Co., Ltd.), and 670 parts by mass of ion-exchanged water are mixed, agitated at 1,500 rpm for 30 minutes with a dissolver, and emulsified to prepare a monomer emulsion. Subsequently, 1.10 parts by mass of Dowfax2A1 (47% solution, manufactured by Dow Chemical Co., Ltd.) and 1,500 parts by mass of ion-exchanged water are charged into a reaction vessel. After heating to 75° C. under a nitrogen stream, 75 parts by mass of a monomer emulsion are added, and then a polymerization initiator solution in which 15 parts by mass of ammonium persulfate is dissolved in 98 parts by mass of ion-exchanged water is added dropwise over 10 minutes. After the reaction is carried out for 50 minutes after the dropping, the remaining monomer emulsion is added dropwise over 220 minutes, and the reaction is further carried out for 50 minutes and then cooled to obtain PSt-1. The solid content concentration is 22.8% by mass. The volume average particle diameter of the resin particles is 0.42 μm.

Preparation of PMMA-1

670 parts by mass of methyl methacrylate, styrene, 25.0 parts by mass of surfactant Dowfax2A1 (47% solution, manufactured by Dow Chemical Co., Ltd.), and 670 parts by mass of ion-exchanged water are mixed, agitated at 1,500 rpm for 30 minutes with a dissolver, and emulsified to prepare a monomer emulsion. Subsequently, 1.10 parts by mass of Dowfax2A1 (47% solution, manufactured by Dow Chemical Co., Ltd.) and 1,500 parts by mass of ion-exchanged water are charged into a reaction vessel. After heating to 75° C. under a nitrogen stream, 75 parts by mass of a monomer emulsion are added, and then a polymerization initiator solution in which 15 parts by mass of ammonium persulfate is dissolved in 98 parts by mass of ion-exchanged water is added dropwise over 10 minutes. After the reaction is carried out for 50 minutes after the dropping, the remaining monomer emulsion is added dropwise over 220 minutes, and the reaction is further carried out for 50 minutes and then cooled to obtain PMMA-1 that is a dispersion of resin particles. The solid content concentration is 22.8% by mass. An average particle diameter of the resin particles is 0.42 μm.

### Example 1

Preparation of Polyimide Precursor Solution

267 parts of ion-exchanged water (hereinafter, referred to as “ion-exchanged water 1”) are heated to 50° C. under a nitrogen stream, and 23 parts of p-phenylene diamine (hereinafter, also referred to as “PDA”) as an aromatic diamine compound, 63 parts of 3,3′,4,4′-biphenyl tetracarboxylic dianhydride (hereinafter, also referred to as “BPDA”) as an aromatic tetracarboxylic dianhydride, 146 parts of PSt-1 as a resin particle dispersion are added while agitating. Next, a mixture of 83 parts of 4-methylimidazole (hereinafter, also referred to as “4-MI”) and 100 parts of ion-exchanged water (hereinafter, “ion-exchanged water 2”) is added under a nitrogen stream at 50° C. over 120 minutes while agitating. After 15 hours at 50° C., a polyimide precursor solution having a solid content concentration of 17.6% is obtained.

Preparation of Porous Polyimide Film

Porous Polyimide Film

A polyimide precursor solution is formed on a glass substrate such that the film thickness after drying is about 30 μm, dried at 90° C. for 1 hour, then the temperature is raised from ascended from 90° C. to 380° C. at a rate of 10° C./min, and after holding thereof at 380° C. for 1 hour, the mixture is cooled to room temperature (25° C., the same applies hereinafter) to obtain a porous polyimide film.

### Examples 2 to 14 and Comparative Examples 1 to 4

In Preparation of polyimide precursor solution, a polyimide precursor solution and a porous polyimide film are obtained in the same manner as in Example 1, except that an addition amount of ion-exchanged water 1, an addition amount of PDA, an addition amount of BPDA, a kind and addition amount of resin particle dispersion, a kind and addition amount of amine compound, and an addition amount of ion-exchanged water 2 are changed as described in Table 1.

For the polyimide precursor solution obtained in each example, “the ratio of the volume of the resin particles to the volume of the amine compound” and “the ratio of the volume of the resin particles to the total volume of the polyimide precursor and the resin particles” are calculated according to the above-mentioned procedure.

For the porous polyimide film obtained in each example, the independent porosity, the porosity, and the relative dielectric constant are measured according to the above-mentioned procedure.

In addition, the air permeability of the porous polyimide film obtained in each example is measured according to the following procedure. The results are shown in Table 1. In addition, “impermeable” means that air does not pass through.

Measurement of Air Permeability

The porous polyimide film is cut into 1 cm² squares (the thickness is a thickness of the porous polyimide film) and used as a sample for measuring air permeability. The sample is set by being interposed between a funnel of a filter holder for decompression filtration (KGS-04 manufactured by ADVANTEC) and a base portion. Then, the filter holder interposing the sample is turned upside down and immersed in water to fill the funnel with water to a predetermined position. An air pressure of 0.5 (0.05 MPas) is applied from a side where the funnel of the base portion is not in contact with the base portion, and the time (seconds) through which 50 ml of air passed is measured and used as the air permeability.

TABLE 1

| | Ion- | | | Resin | | | | | | |
|---|---|---|---|---|---|---|---|---|---|---|
| | exchanged | | | particle | | | Amine | | | |
| | water 1 | PDA | BPDA | dispersion | | | compound | | | |
| | Addition | Addition | Addition | | Addition | Particle | | | Boiling | Addition |
| | amount | amount | amount | | amount | diameter | | Classifi- | point | amount |
| | (parts) | (parts) | (parts) | Kind | (parts) | (μm) | Kind | cation | (° C.) | (parts) |
| Example 1 | 267 | 23 | 63 | PSt-1 | 146 | 0.42 | 4-MI | Tertiary | 263 | 83 |
| | | | | | | | | amine | | |
| Example 2 | 257 | 22 | 61 | PMMA-1 | 159 | 0.42 | 4-MI | Tertiary | 263 | 91 |
| | | | | | | | | amine | | |
| Comparative | 267 | 23 | 63 | PSt-1 | 146 | 0.42 | BAPA | Secondary | 235 | 83 |
| Example 1 | | | | | | | | amine | | |
| Example 3 | 267 | 23 | 63 | PSt-1 | 146 | 0.42 | DIPA | Secondary | 250 | 83 |
| | | | | | | | | amine | | |
| Example 4 | 267 | 23 | 63 | PSt-1 | 146 | 0.42 | 2-E- | Tertiary | 293 | 83 |
| | | | | | | | 4-MI | amine | | |
| Comparative | 267 | 23 | 63 | PSt-1 | 146 | 0.42 | 3-PA | Primary | 330 | 83 |
| Example 2 | | | | | | | | amine | | |
| Comparative | 267 | 23 | 63 | PSt-1 | 146 | 0.42 | 4-MI | Tertiary | 263 | 159 |
| Example 3 | | | | | | | | amine | | |
| Example 5 | 267 | 23 | 63 | PSt-1 | 146 | 0.42 | 4-MI | Tertiary | 263 | 152 |
| | | | | | | | | amine | | |
| Example 6 | 267 | 23 | 63 | PSt-1 | 146 | 0.42 | 4-MI | Tertiary | 263 | 55 |
| | | | | | | | | amine | | |
| Comparative | 267 | 23 | 63 | PSt-1 | 146 | 0.42 | 4-MI | Tertiary | 263 | 54 |
| Example 4 | | | | | | | | amine | | |
| Example 7 | 322 | 38 | 75 | PSt-1 | 76 | 0.42 | 4-MI | Tertiary | 263 | 43 |
| | | | | | | | | amine | | |
| Example 8 | 318 | 27 | 74 | PSt-1 | 80 | 0.42 | 4-MI | Tertiary | 263 | 45 |
| | | | | | | | | amine | | |
| Example 9 | 249 | 22 | 59 | PSt-1 | 170 | 0.42 | 4-MI | Tertiary | 263 | 97 |
| | | | | | | | | amine | | |
| Example 10 | 245 | 21 | 58 | PSt-1 | 175 | 0.42 | 4-MI | Tertiary | 263 | 100 |
| | | | | | | | | amine | | |
| Example 11 | 315 | 27 | 74 | PSt-1 | 84 | 0.42 | 4-MI | Tertiary | 263 | 48 |
| | | | | | | | | amine | | |
| Example 12 | 322 | 26 | 73 | PSt-1 | 88 | 0.42 | 4-MI | Tertiary | 263 | 50 |
| | | | | | | | | amine | | |
| Example 13 | 256 | 22 | 61 | PSt-1 | 160 | 0.42 | 4-MI | Tertiary | 263 | 91 |
| | | | | | | | | amine | | |
| Example 14 | 253 | 22 | 60 | PSt-1 | 165 | 0.42 | 4-MI | Tertiary | 263 | 94 |
| | | | | | | | | amine | | |

| | | Volume | | | | | |
|---|---|---|---|---|---|---|---|
| | Ion- | ratio | | Porous | | | |
| | exchanged | | Particle/ | polyimide film | | | |
| | water 2 | | PI + | Independent | | | |
| | Addition | | particle | Porosity | Porosity | Air | Relative |
| | amount | Particle/ | (% by | (% by | (% by | permeability | dielectric |
| | (parts) | amine | volume) | volume) | volume) | (second) | constant |
| Example 1 | 100 | 0.40 | 35 | 55 | 55 | Impermeable | 1.9 |
| Example 2 | 100 | 0.40 | 35 | 55 | 55 | Impermeable | 1.9 |
| Comparative | 100 | 0.40 | 35 | 60 | 25 | Impermeable | 2.8 |
| Example 1 | | | | | | | |
| Example 3 | 100 | 0.40 | 35 | 55 | 55 | Impermeable | 1.9 |
| Example 4 | 100 | 0.40 | 35 | 55 | 55 | Impermeable | 1.9 |
| Comparative | 100 | 0.40 | 35 | 25 | 55 | 30 | 1.9 |
| Example 2 | | | | | | | |
| Comparative | 100 | 0.21 | 35 | 55 | 25 | Impermeable | 2.8 |
| Example 3 | | | | | | | |
| Example 5 | 100 | 0.22 | 35 | 55 | 40 | Impermeable | 2.3 |
| Example 6 | 100 | 0.61 | 35 | 45 | 58 | Impermeable | 1.8 |
| Comparative | 100 | 0.62 | 35 | 25 | 65 | 20 | 1.8 |
| Example 4 | | | | | | | |
| Example 7 | 100 | 0.40 | 19 | 45 | 45 | Impermeable | 2.1 |
| Example 8 | 100 | 0.40 | 20 | 50 | 50 | Impermeable | 2.0 |
| Example 9 | 100 | 0.40 | 40 | 50 | 58 | Impermeable | 1.8 |
| Example 10 | 100 | 0.40 | 41 | 45 | 60 | Impermeable | 1.8 |
| Example 11 | 100 | 0.40 | 21 | 52 | 50 | Impermeable | 2.0 |
| Example 12 | 100 | 0.40 | 22 | 60 | 52 | Impermeable | 2.0 |
| Example 13 | 100 | 0.40 | 38 | 60 | 55 | Impermeable | 1.9 |
| Example 14 | 100 | 0.40 | 39 | 53 | 57 | Impermeable | 1.8 |

The description in Table 1 will be described below.

Particle diameter (μm): Volume average particle diameter of the resin particles.

Particle/amine: Ratio of volume of resin particles to volume of amine compound (volume of resin particles/volume of amine compound)

Particle/PI+particle (% by volume): Proportion of volume of resin particles to total volume of polyimide precursor and resin particles

The abbreviations of the amine compounds shown in Table 1 will be described below.

4-MI: 4-methylimidazole (boiling point: 263° C.)

BAPA: Bis(3-aminopropyl)amine (boiling point: 235° C.)

DIPA: Diisopropanolamine (boiling point: 250° C.)

2-E-4-MI: 2-ethyl-4-methylimidazole (boiling point: 293° C.)

3-PA: 3-phenoxyaniline (boiling point: 330° C.)

From the above results, it is recognized that the polyimide precursor solution of the present example can obtain a porous polyimide film having a high porosity and a high independent porosity.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A polyimide precursor solution comprising:
a polyimide precursor that is a polymer of an aromatic tetracarboxylic dianhydride and an aromatic diamine compound;
resin particles;
an aqueous solvent containing water; and
an amine compound having a boiling point of equal to or higher than 250° C. and equal to or lower than 300° C.,
wherein a ratio of a volume of the resin particles to a volume of the amine compound (volume of resin particles/volume of amine compound) is equal to or more than 0.22 and equal to or less than 0.61.

2. The polyimide precursor solution according to claim 1,
wherein a proportion of the volume of the resin particles to a total volume of the polyimide precursor and the resin particles is equal to or more than 20% by volume and equal to or less than 40% by volume.

3. The polyimide precursor solution according to claim 2,
wherein the proportion of the volume of the resin particles to the total volume of the polyimide precursor and the resin particles is equal to or more than 22% by volume and equal to or less than 38% by volume.

4. The polyimide precursor solution according to claim 1,
wherein the amine compound is at least one selected from the group consisting of a secondary amine compound and a tertiary amine compound.

5. The polyimide precursor solution according to claim 2,
wherein the amine compound is at least one selected from the group consisting of a secondary amine compound and a tertiary amine compound.

6. The polyimide precursor solution according to claim 3,
wherein the amine compound is at least one selected from the group consisting of a secondary amine compound and a tertiary amine compound.

7. The polyimide precursor solution according to claim 4,
wherein the secondary amine compound is at least one selected from the group consisting of dialkylamine and secondary amino alcohol, and
the tertiary amine compound is at least one selected from the group consisting of trialkylamine, tertiary amino alcohol, and imidazoles.

8. The polyimide precursor solution according to claim 5,
wherein the secondary amine compound is at least one selected from the group consisting of dialkylamine and secondary amino alcohol, and
the tertiary amine compound is at least one selected from the group consisting of trialkylamine, tertiary amino alcohol, and imidazoles.

9. The polyimide precursor solution according to claim 6,
wherein the secondary amine compound is at least one selected from the group consisting of dialkylamine and secondary amino alcohol, and
the tertiary amine compound is at least one selected from the group consisting of trialkylamine, tertiary amino alcohol, and imidazoles.

10. The polyimide precursor solution according to claim 1,
wherein a volume average particle diameter of the resin particles is equal to or more than 0.1 μm and equal to or less than 1.0 μm.

11. The polyimide precursor solution according to claim 2,
wherein the volume average particle diameter of the resin particles is equal to or more than 0.1 μm and equal to or less than 1.0 μm.

12. The polyimide precursor solution according to claim 3,
wherein the volume average particle diameter of the resin particles is equal to or more than 0.1 μm and equal to or less than 1.0 μm.

13. The polyimide precursor solution according to claim 4,
wherein the volume average particle diameter of the resin particles is equal to or more than 0.1 μm and equal to or less than 1.0 μm.

14. The polyimide precursor solution according to claim 5,
wherein the volume average particle diameter of the resin particles is equal to or more than 0.1 μm and equal to or less than 1.0 μm.

15. The polyimide precursor solution according to claim 6,
wherein the volume average particle diameter of the resin particles is equal to or more than 0.1 μm and equal to or less than 1.0 μm.

16. The polyimide precursor solution according to claim 7,
wherein the volume average particle diameter of the resin particles is equal to or more than 0.1 μm and equal to or less than 1.0 μm.

17. The polyimide precursor solution according to claim 8,
wherein the volume average particle diameter of the resin particles is equal to or more than 0.1 μm and equal to or less than 1.0 μm.

18. The polyimide precursor solution according to claim 9,
wherein the volume average particle diameter of the resin particles is equal to or more than 0.1 μm and equal to or less than 1.0 μm.

19. A porous polyimide film,
wherein an independent porosity is equal to or more than 40% by volume and equal to or less than 60% by volume, and
a porosity is equal to or more than 40% by volume and equal to or less than 60% by volume.

20. An insulated wire comprising:
a conductor; and
the porous polyimide film according to claim 19 on a surface of the conductor.
